(19) United States
(12) Patent Application Publication
(10) Pub. No.: US 2006/0250811 A1
(43) Pub. Date: Nov. 9, 2006

(54) Head light assembly with Fresnel lens

(76) Inventors: Hsiang-Chen Wu, Tainan (TW); Ching-Hsien Hwang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/122,080

(22) Filed: May 5, 2005

(51) Int. Cl. B60Q 1/04; F21V 13/12; F21V 7/00

(52) U.S. Cl. 362/539; 362/516; 362/520

(57) ABSTRACT

A head light assembly includes a reflector having a multi-oval reflection surface and a lamp is located at a first focus position of reflection surface of the reflector so that light beams reflected by the reflection surface are focus at a second focus position. A block plate is movably located in the reflector and located between the lamp and a second focus position. A Fresnel lens is connected to the reflector so that the light beams passing the second focus position go through the Fresnel lens and becomes parallel light beams.

### FIELD OF THE INVENTION

The present invention relates to a Fresnel lens assembly, especially for the use of the Fresnel lens in Poly-Ellipsoid System (PES).

### BACKGROUND OF THE INVENTION

There are several vehicle head light assemblies used in modern vehicles so as to effectively protect the drivers, such as Adaptive Front-lighting System (AFS) and Poly-Ellipsoid System (PES).

As shown in FIG. 6 which shows parallel light beams go through a spherical lens 3 and the beams cannot focus at a certain point so that the light beams are difficult to be controlled as desired. Therefore, as shown in FIG. 7, an asphserical lens 4 is used to improve the shortcoming for spherical lens 3. Most of the head light assemblies use aspherical lenses to obtain a controlled light beam.

FIGS. 4 and 5 show a head light assembly 3 which is composed of a reflector 21, a lamp 22 which is located at a first focus 7 for the reflector 21, a block plate 23 and an aspherical lens 24. The light beams from the lamp 22 are reflected and focus at the second focus 8 and the beams then go through the aspherical lens 24 to form parallel light beams. The area of the aspherical lens 24 are smaller than conventional glass spherical lens and the aspherical lens 24 is cooperated with Adaptive Front-lighting System (AFS).

However, the asphercial lens 24 is heavy so that the center of weight of the whole light assembly is moved forward so that the electric adjustment device for turning the light assembly becomes difficult.

The present invention intends to provide a head light assembly that uses Fresnel lens which is light in weight and smaller than the aspherical lens.

### SUMMARY OF THE INVENTION

The present invention relates to head light assembly which comprises a reflector having a reflection surface and a lamp is located at a first focus position of the reflection surface of the reflector. A block plate is movably located in the reflector and located between the lamp and a second focus position where the light beams reflected by the reflection surface are converged at the second focus position. A Fresnel lens is connected to the reflector and the second focus position located between the block plate and the Fresnel lens. The Fresnel lens has concentric loop structure.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the head light assembly of the present invention;

FIG. 2 shows the arrangement of the components of the head light assembly of the present invention;

FIG. 3 shows part of the light beams are blocked by the block plate;

FIG. 4 is an exploded view to show a conventional head light assembly with an aspherical lens;

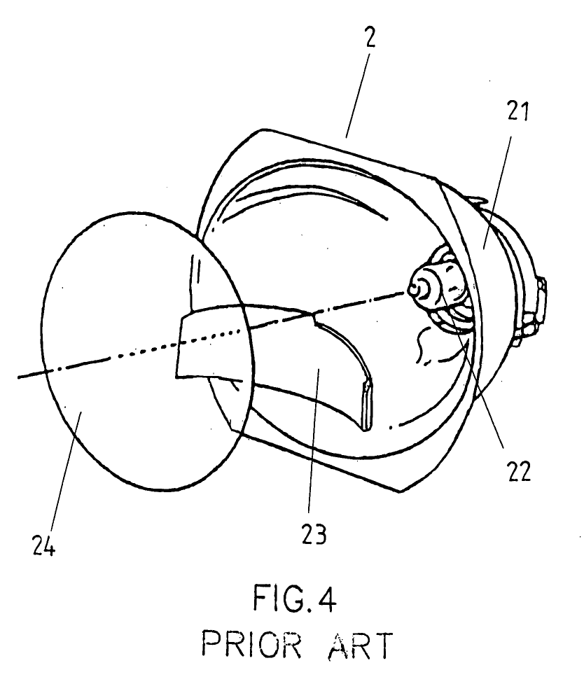

FIG. 5 shows the arrangement of the components of the conventional head light assembly in FIG. 4;

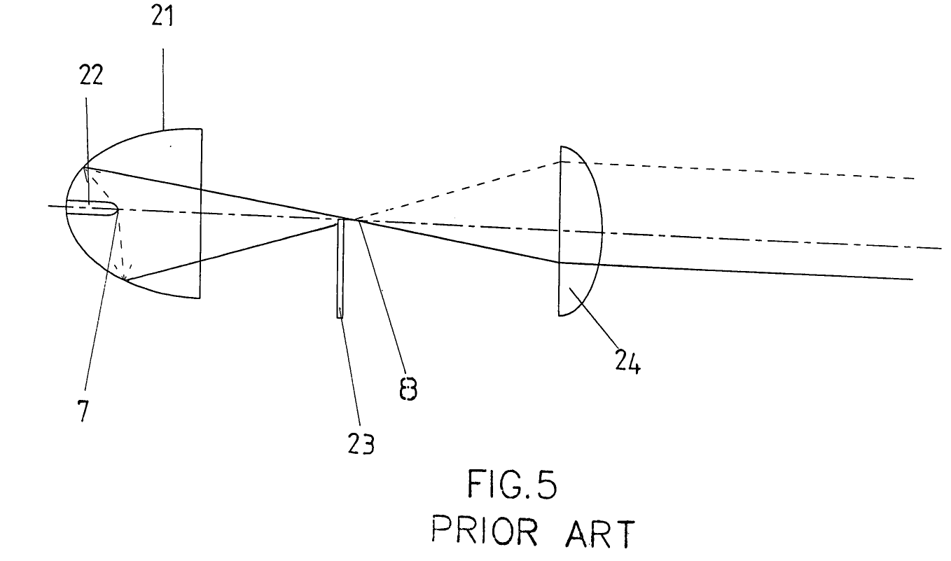

FIG. 6 shows the light beams passing through a spherical lens cannot focus at a point, and

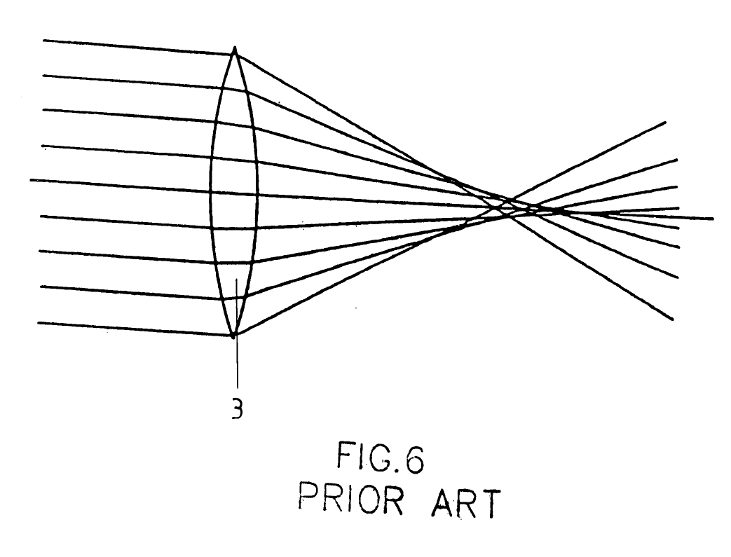

FIG. 7 shows the light beams passing through an aspherical lens focus at a point.

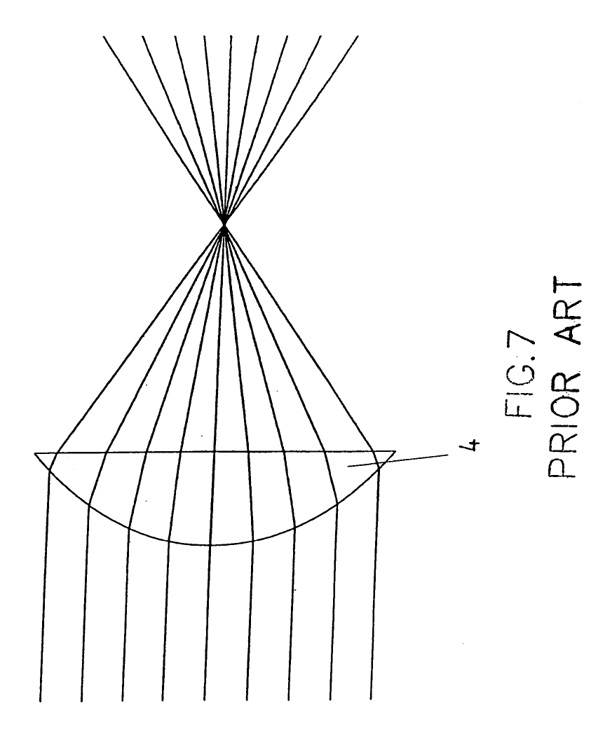

### DETAILED DESCRIPTION OF THE PREFERRED EMBODIMENT

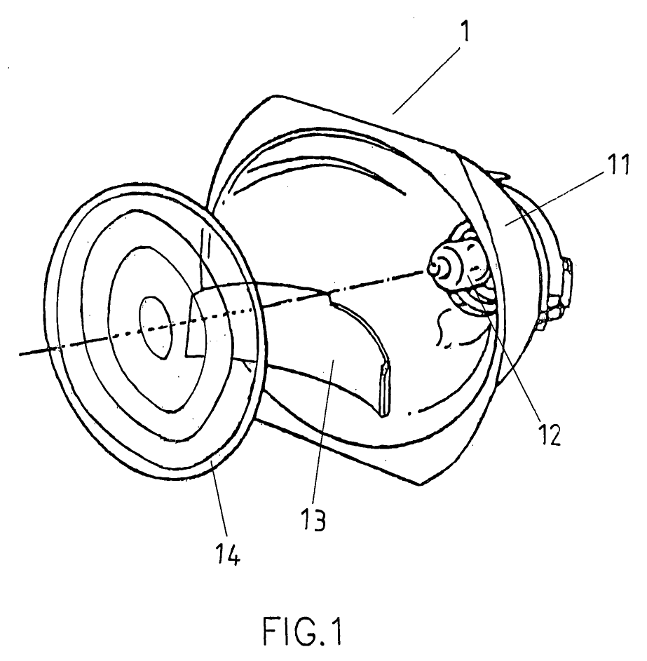

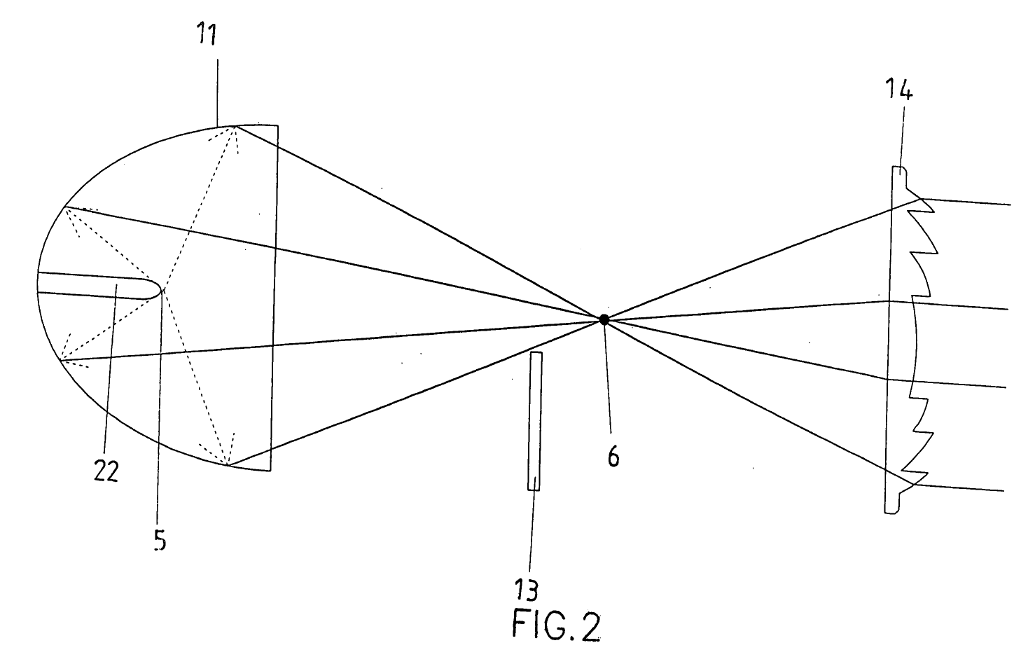

Referring to FIGS. 1 and 2, the head light assembly 1 of the present invention comprises a reflector 21 with a multiple-oval reflection surface and a lamp 22 is located at a first focus position 5 of the reflection surface of the reflector 21. A block plate 23 is movably located in the reflector 21 and located between the lamp 22 and a second focus position 6. A Fresnel lens 14 is connected to the reflector 21 and the second focus position 6 is located between the block plate 23 and the Fresnel lens 14. The Fresnel lens 14 is made by plastic material and has concentric loop structure. Light beams coming from the lamp 22 are reflected by the reflection surface of the reflector 11 focus at the second focus position 6 and then go through the Fresnel lens 14 in a parallel form.

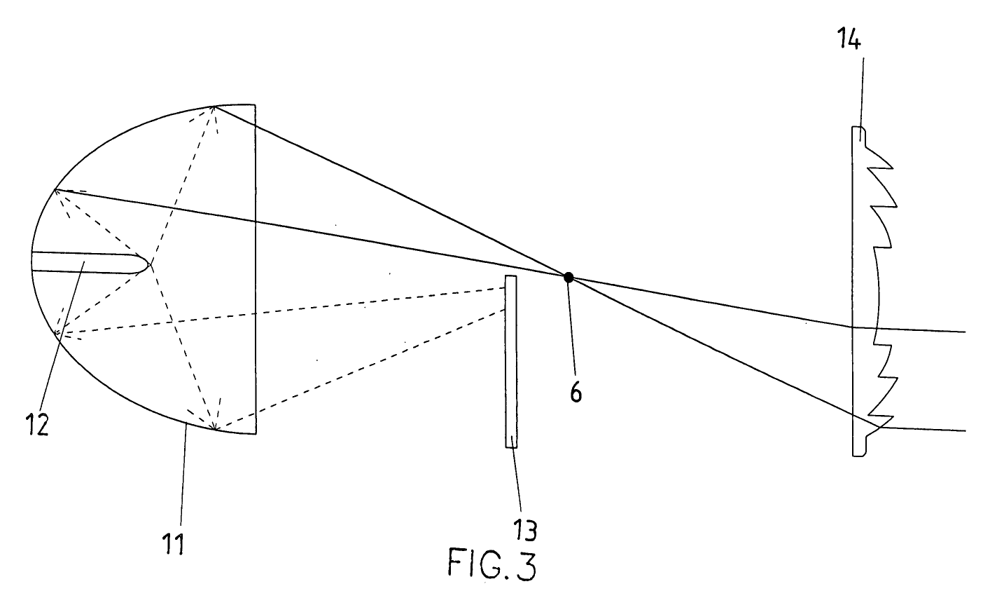

As shown in FIG. 3, the block plate 13 can be moved to block part of the light beams reflected by the reflection surface of the reflector 11 so that only a part of the light beams pass through the Fresnel lens 14 and becomes low beam of the head light assembly 1.

The Fresnel lens 14 is made by plastic material and can be easily manufactured with low-cost molds. The Fresnel lens 14 is light in weight so that the driving device can easily pivot the Fresnel lens 14. The reflection surface of the reflector 11 can also be a curve surface as long as the light beams can be reflected and focused at the second focus position 6.

While we have shown and described the embodiment in accordance with the present invention, it should be clear to those skilled in the art that further embodiments may be made without departing from the scope of the present invention.

What is claimed is:

1. A head light assembly comprising:
a reflector having a reflection surface and a lamp located at a first focus position of the reflection surface of the reflector, a block plate movably located in the reflector and located between the lamp and a second focus position, a Fresnel lens connected to the reflector, the second focus position located between the block plate and the Fresnel lens, the Fresnel lens having concentric loop structure.

2. The assembly as claimed in claim 1, wherein the reflection surface of the reflector is a multiple-oval surface.

3. The assembly as claimed in claim 1, wherein Fresnel lens is made by plastic material.
